(19) United States
(12) Patent Application Publication
(10) Pub. No.: US 2007/0221032 A1
(43) Pub. Date: Sep. 27, 2007

(54) Secure band saw work support table

(75) Inventor: Stephen Mangano, North Reading, MA (US)

Correspondence Address: Law Offices of Michael Leccese, P.C.;Michael Leccese, Esq., Suite 202, 790 Turnpike St., North Andover, MA, 01845, US

(73) Assignee: Richen Enterprise, Inc., Woburn, MA (US)

(21) Appl. No.: 11/388,266

(22) Filed: Mar. 24, 2006

(51) Int. Cl. B23D 55/02

(52) U.S. Cl. 83/810

(57) ABSTRACT

A secure band saw table support apparatus, proving stability and for adjusting the worktable of a band sawing machine. The secure band saw table support having a single piece turning member affixed to the bottom side of the worktable. The single piece turning member having at least two arc shaped protrusions, wherein the two arced shaped protrusions being one member and attachable to the bottom side of the band saw table. The arced shaped protrusions as part of the turning member having arc shaped slots therein. A base piece also included which is attached to the band saw base and table support turning member. Also included is a guiding shaft to assure smooth operation, an adjusting shaft having a handle wherein and operator can turn the handle adjusting the inclination of the table and a pressing shaft having a handle so that the handle can be tightened wherein locking the table in place preventing the table from movement.

### FIELD

The invention relates generally to a secure and adjustable band sawing table, more particularly an improved band sawing table support. Specifically, an improved band sawing table support which includes being angularly adjustable without being unstable, unsteady or shaky during normal use loading.

### BACKGROUND

In the past, inclination degree of the work table of a band sawing machine or angularly adjustable saw table's exhibit unsteadiness during normal use. Typically a band saw table is supported by an apparatus that is used for adjusting the angular relationship of the table to the blade so the user can make angled cuts in his work piece by resting the work piece on the angled table and pushing it through the saw blade. This adjusting apparatus can take the form of many different types of mechanisms. Such tilting, angling or inclination degree tables can be found in prior art as disclosed in U.S. Pat. No. 110,671 and U.S. Pat. No. 1,139,659 which employs among other items a mating gear in communication with a radial or diametric rack arrangement such that the gear is turned to adjust the angular relationship between the work table and saw blade. More recently, prior art U.S. Pat. No. 6,644,163 B2 has taught among other items an adjustable worktable for a band sawing machine comprising two arch shaped turning pieces affixed to the bottom side of the band sawing worktable wherein said base piece is positioned between the two arch shaped turning pieces.

Commonly the prior art traditional way of constructing an inclination work table having the two arch shaped turning pieces fixedly attached to a work table results in one arc shaped piece being mis-positioned with respect to the other truing piece, this is due in part to their individual construction. One way this mis-position may occur would be that the table being supported by the two pieces allows for movement of the table with respect to each of the turning pieces. In other words the two piece turning member construction does not property support the table in a ridged fashion required to support the table in a secure manner. Typically when the table is loaded during angular adjustment or just from mere use, introducing loads and forces that deflect bend or warp the table, this deflection could cause the table to be mis-shapen perhaps resulting in inconsistent or unexpected operation of the table support, an example of this inconsistent operation would be a when a work piece is placed on the top of the band saw table and pushed through the saw blade creating loads and forces on the table and support deflecting the table (making the table unsecured and shaky) resulting in an imprecise work piece cut or resulting in altering the table alignment. Frequently the prior art band saw table will deflect, bend, warp and become un-secure, this is due in part to the two piece construction of the turning pieces. The traditional way of constructing these angular adjustable tables have been found by the inventor to be weak and subject to table flex and misalignment making the table and support difficult to use and even un safe. In band saw applications it is desirable that the table have a predetermined alignment with the blade so work piece cuts can be made to the desired accuracy and safety. Consequently the inventor has developed a band saw table support that is more supportive more secure, effective and efficient than past table supports.

In other words the two piece turning member construction does not property support the table in a ridged fashion required to support the table in a secure manner. Typically when the table is loaded during angular adjustment or just from use introducing forces that deflect the table, this deflection causes the table to be deformed perhaps resulting in inconsistent or unexpected operation of the table and table support system, an example of this inconsistent operation would be a work piece, perhaps a heavy member, is placed a top the table and pushed through the saw blade creating loading and forces on the table and support deflecting the table, moving the table (making the table unsecured and shaky) consequentially causing an imprecise work piece cut or table misalignment. Frequently the table will deflect, bend, warp or become un-secure, this is due in part to the two piece construction of the turning pieces. The two piece turning member construction does not provide a for a secure table support. In addition this two piece independent table support turning member pieces can twist or bend during use even with the table attached. It is also common among the arts that a user can bump, rest a large work piece on the band saw table or even use the table as a handle to push or pull the saw to move the band saw. These actions create great loads on the table that can move the table out of alignment, and in many cases with the prior art construction bend or twist the independent arced shaped support pieces, sometimes permanently making it difficult or even impossible to realign the table. In cases with high loading the table can be overloaded and deflected in such a way to permanently deflect the table damaging the table.

In yet another problem with the prior art that the inventor to the present invention has recognized and improved upon is the smooth operation of the system viability or adjustability. Prior art adjustable table saw table supports include an adjusting shaft that has gears engaging with racks, rack defined as a toothed member that meshes with a gear or gearwheel, pinion, or other toothed machine part, the prior art show the rack separately mounted to the turning piece, typically one gear on either end of the adjusting shaft engaging a rack on either arc shaped piece of the turning member, the turning pieces for driving the turning pieces and the worktable. Specifically, the prior art comprises two gear racks and two gears, one rack on each independent turning piece and one gear on either end of the adjusting shaft. The inventor of the present invention has found that this two gear system working two turning members is inefficient and unnecessary. The inventor has found the two gear system is difficult to align and frequently binds, one independent piece moves differently than the other placing excessive force on one or the other when adjusted, one rack and pinion trying to make the other work identically. This condition is exacerbated when the table is loaded, for example a user places a work piece on the table stressing and deflecting a portion of the table then adjusting the table loading one of the racks more than the other causing a binding of one of the racks. The inventor of the present invention has solved this problem by the single pieces turning member having only one rack formed into one of the protrusions of the turning pieces. Not only does the single piece turning member add to the rigidity of the table support system the single rack and gear provide more effective and efficient table adjustment. Not only does the prior art provide for a system that is weak and subject to misalignment and binding the prior art shows a gear and pinion that is slight in size and shape where the present invention shows a robust and sturdy construction.

The inventor of the present invention has also discovered that prior table support systems which mount beneath the band saw table and upon the band saw machine are difficult to align and difficult to fine adjust the table relationship to the blade. The prior art band saw table and adjustment of the band saw table that fixedly attaching the support system to the band saw then affixing the table to the support provides no flexibility in adjustment between the band saw table support system and the band saw. Typically the band saw support system is placed upon the band saw and fixedly attached in place usually by using threaded fasteners then the table is mounted upon the support. Frequently the initial table top setting or calibration is desired to be perpendicular to the blade. Then the band saw table support inclines or tilts to allow for angled cuts but as the table is fixed in place, typically to make a ninety degree cut, in other works the table of the band saw is ninety degrees in relation to the blade, at a zero setting or at initial installation. Typically tolerances in manufacturing of band saw bases and table supports results in variability from machine to machine making it difficult to get a precise initial perpendicular setup. To solve this problem the inventor has included table support leveling members on the base piece so the support system can be finely adjusted typically during assembly, the inventor has used a plurality of adjusting feet to adjust the table support to achieve the fine adjustment to attain the desired perpendicularity degree in relationship to the blade support table relationship, in most cases a zero setting or primary band saw set up.

The traditional way of constructing these angular adjustable tables have been found by the inventor to be weak and subject to table flex making the table and support difficult to use and even unsafe. Consequently the inventor has developed a band saw table support that is more supportive more secure, effective and efficient than past table supports.

### SUMMARY

It is an object of this invention to provide an apparatus and method of constructing a secure adjustable secure band saw work support table system. More particularly, embodiment of this invention relates to a manner in which to use common building materials and methods in constructing and using an incline adjustable band saw table more effectively and efficiently than in the past. Using embodiments and implementations of this invention will allow the user to construct and use an adjustable tilting band saw work table having the same if not better properties and better function as previous apparatus. Moreover, embodiments and implementations of this invention will allow the user to construct the adjustable secure band saw work support table system more efficiently and effectively, resulting in time and energy savings, enhancing strength function and appearance. This invention is directed toward adjustable inclined band sawing machine work tables where a user can adjust the tilt of a band saw work table such that the table is in an angular relationship to the cutting blade. Band sawing machines generally operate having two wheels being in substantially the same plane on different centerlines in which a continuous blade band is in communication with the wheels, one wheel is a driven wheel the other is an idler wheel. The drive wheel turns the blade being in communication with the wheel is also in motion allowing an operator to push a work piece against the blade with cutting teeth cutting the work piece. Typically the work piece support table is substantially perpendicular to the cutting blade however it is frequently desirable to have an angled cut which may be accomplished by having the work table tilt or incline in relationship to the blade. The adjustable incline work table provides for the user to make an angled cut in the work piece to be cut by merely adjusting the table resting the work piece on the table and pushing the work piece through the blade.

Furthermore this invention will supply the work table with better rigidity than in the past eliminating the need for additional bracing of the work table. The invention provides for a stable secure platform for adjusting and working on a band saw table. Implementation of this invention include the work table support system comprising a homogenous turning member that is attached beneath the band saw machine work table, the homogenous turning member provides table support in a more effective and efficient way then in the past. The single piece construction of this turning member allow for a rigid secure platform from which to attach the table. It is a further object of this invention to provide an apparatus and method that is simple by design and efficient in method and use.

In yet another illustration of the present invention, the band saw table support inclines or tilts to allow for angled cuts but as the table is fixed in place, typically to make a ninety degree cut, in other works the table of the band saw is ninety degrees in relation to the blade. The inventor has incorporated a plurality of adjusting feet to adjust the table support to achieve the fine adjustment to attain the ninety degree blade, support table relationship. As the table support system mount onto the band saw the user can adjust the angular relationship between the band sawing blade and the table.

Illustrative embodiments and modes of operation of the present invention have been described in this specification. The invention which is intended to be protected herein, however, is not to be construed as limited to the particular embodiments disclosed, since these embodiments are to be regarded as illustrative rather than restrictive. Variations and changes may be made by others without departing from the spirit of this invention. Accordingly, it is expressly intended that all such variations and changes which fall within the spirit and scope of the claims be embraced thereby.

### BRIEF DESCRIPTION OF DRAWINGS

Other objects, features, and advantages will occur to those skilled in the art from the following description of an embodiment and the accompanying drawings, in which:

FIG. 1, shows a perspective view of the band saw work support table assembly and work table.

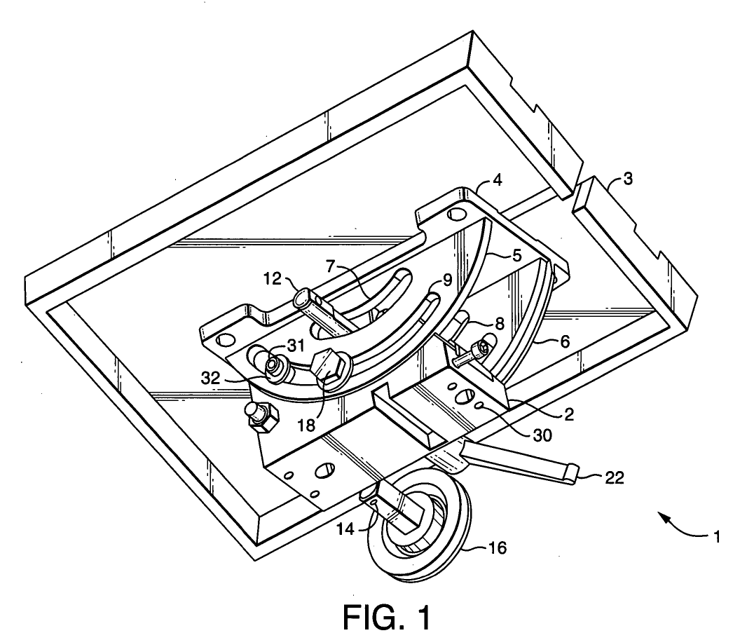

FIG. 2, shows a side view of the band saw work support table assembly.

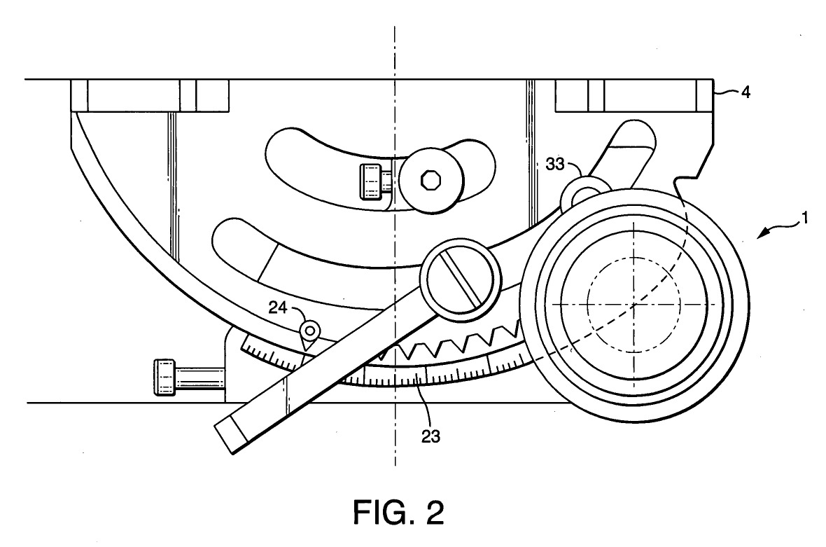

FIG. 3, shows an end view of the band saw work support table assembly.

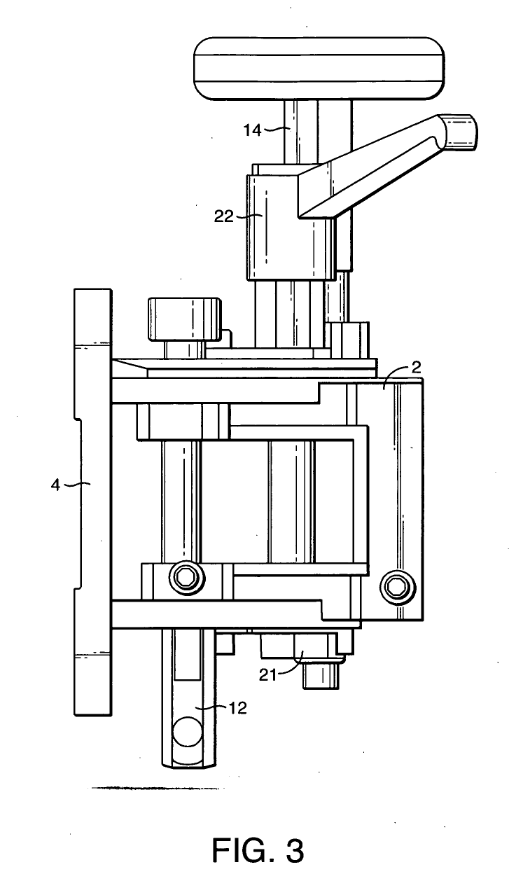

FIG. 4, shows a bottom view of the band saw work support table assembly.

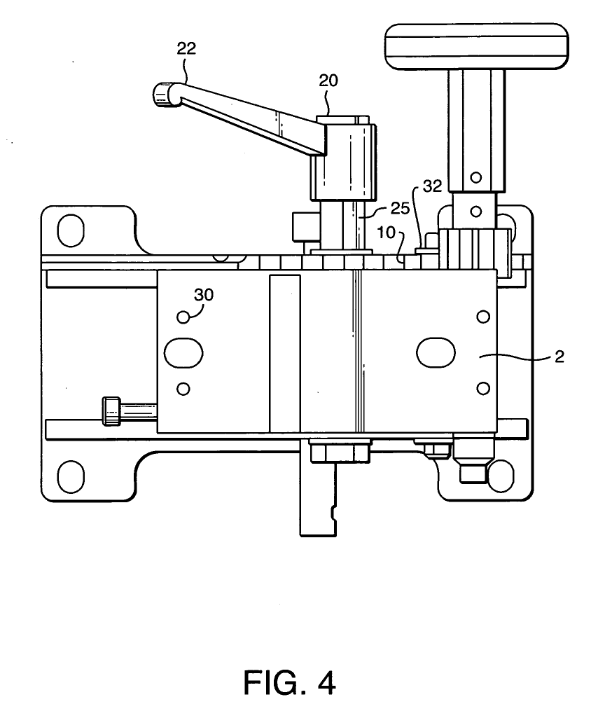

FIG. 5, shows a perspective view of the single piece turning member.

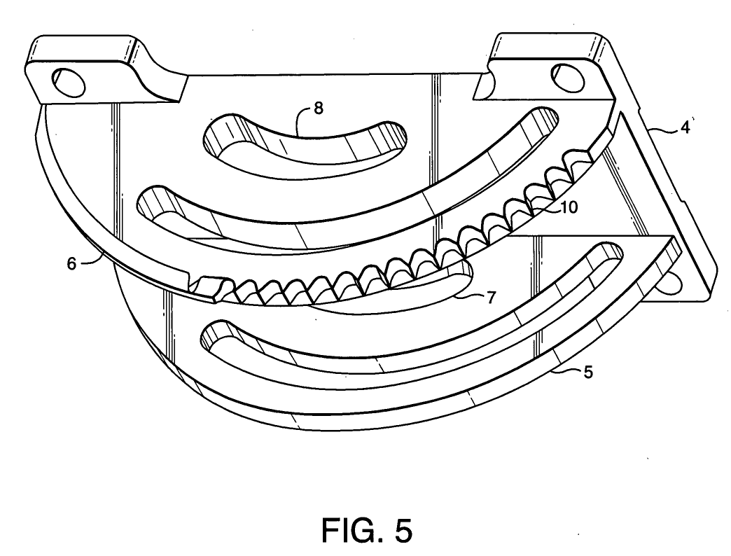

FIG. 6, shows a perspective view base member.

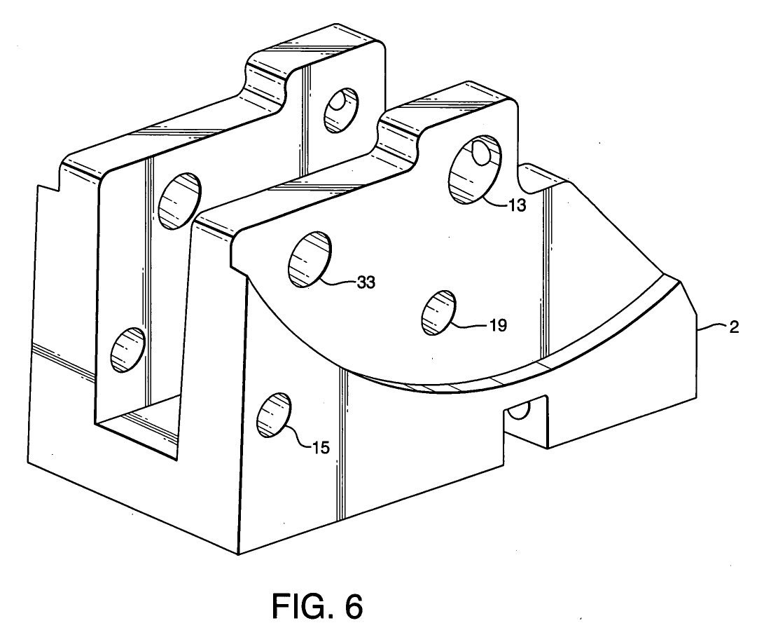

FIG. 7, shows a perspective view adjusting shaft assembly.

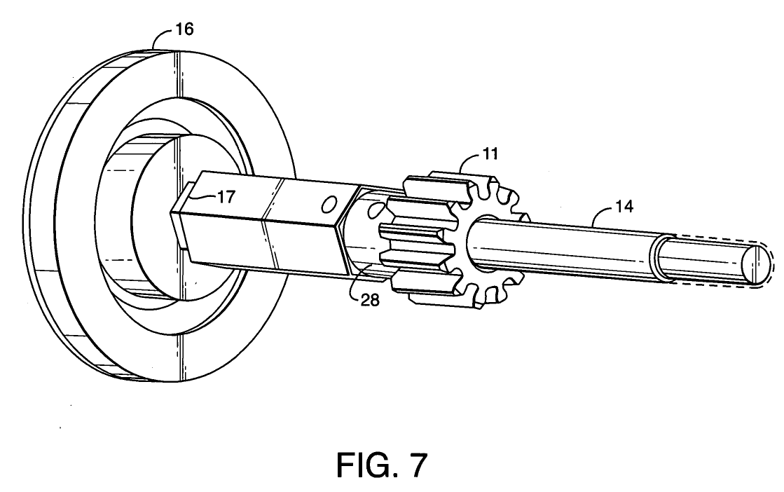

FIG. 8, shows a bottom view having handle assembly detail.

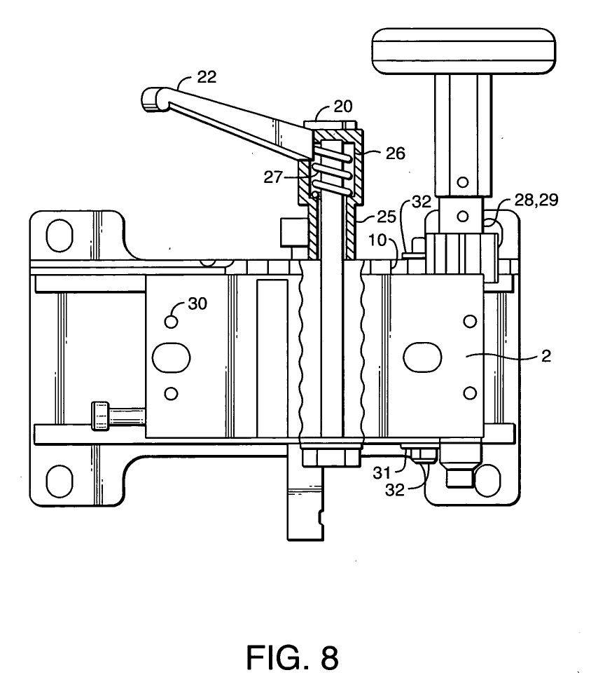

FIG. 9, shows a perspective view of the band saw work support.

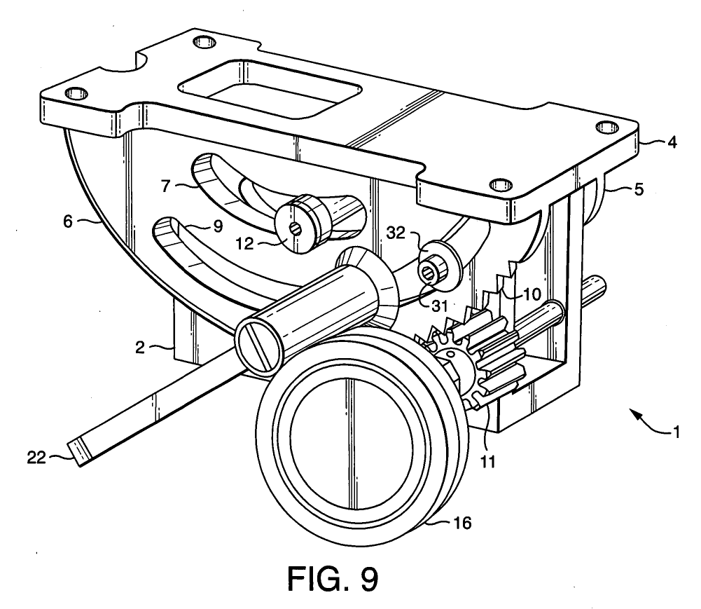

### DETAILED DESCRIPTION

An adjustable secure band saw work support table system 1 to provide a secure ridged table support. A band saw machine work piece table support having a base member 2 provided beneath a band saw machine worktable 3 fixedly attached to a band saw machine base (not shown). The work support table is fixedly attached to the band sawing machine and the work piece table allowing the table to be angled with respect to the band saw blade, in other words, the table system allows for the work table to be tilted or angled without sacrificing table stability. Typically the work support table is bolted or mounted to the band saw machine using threaded fasteners. The table 3 being supported by a single piece turning member 4 affixed to the bottom side of the worktable 3 creating a strong secure work piece platform. The single piece turning member 4 is constructed by having at least two arc shaped protrusions 5,6, a first arc shaped protrusion 5 and a second arch shaped protrusion 6. Each of the arc shaped turning member protrusions having at least two arched slots wherein the first arch shaped slot 7 in the first shaped protrusion 5 is substantially coincident to another similar arch shaped slot 8 in the second shaped protrusion 6.

The base 2 is fit between the first arch shaped protrusion 5 and the second arch shaped protrusion 6. The single piece turning member affixed to the bottom side of the worktable 3, this single piece turning member 4 design allows for a the band saw table assembly to be nonflexible and secure such that the table and table assembly has little to no bend or flex while under load. The base 2 is fit between the two arcs shaped turning members protrusions 5,6. A first arch shaped slot 7 and a second arch shaped slot 9 are formed within the first arch shaped protrusion 5 and similarly in the second arch shape protrusion wherein the arc shaped slots are substantially coincident with each other in each of the protrusions. The first arch shaped slot 7 and the second arc shaped slot 9 are positioned on different radial distances from the same central axis. At least one of the two arch protrusions having a gear toothed rack 10 formed into the arc shaped member 6 wherein the gear toothed rack is adapted to engage a mating gear 11. An arrangement guiding shaft blade bearing support member extending through a hole in the base and into each of the first arched shaped guiding slots of the single piece turning member,

The adjustable secure band saw work support table system 1 also includes a blade member support guiding shaft 12 extending through a first hole 13 in the base 2 and into each of the first arched shaped guiding slots 7 of the single piece turning member 4 allowing for smooth operation. In one illustration adjustable secure band saw work support table system 1 including an elongated second guiding shaft 31, the second guiding shaft 31 having two ends the second guiding shaft extending substantially parallel to the pressing shaft 18 and through a hole 33 in the base piece 2, the second guiding shaft 31 having collars 32 on the two ends wherein the collars are in communication with the one piece turning member 4 guiding the turning member as the turning member 4 is moving.

The work support table also having an elongated adjusting shaft 14 extending substantially parallel to the adjustable secure band saw work support table system 1 blade member guiding shaft 12 and through a second hole 15 in the base piece 2 such that two ends of the shaft terminate adjacent to an outside periphery of the arc shaped turning member 4. The elongated adjusting shaft 14 having a pinion mating gear 11 engaging with the gear teeth 10 of the turning member 4. The elongated adjusting shaft including a turning knob 16 located on the distal end 17 of the shaft in proximity to the pinion gear 11 such that a person can hold and torque the turning knob 16 thereby turning the gear resulting in turning the table 3. In one illustration the adjustable secure band saw work support table as further comprises an extension member 28 to the elongated adjusting shaft 14, wherein the turning knob 16 is spaced away from the locking handle 22 such that the locking handle and the turning knob 16 are spaced apart. The turning now being distanced away from the locking handle allows for an operator to have clearance for his hand to better operate the turning knob and locking handle.

The system includes a lock assembly to lock the table in place so that the table does not move in operation. The lock comprises an elongated pressing shaft 18 extending substantially parallel to the guiding shaft 12 and through a third hole 19 in the base piece 2 and into each of the second arched shaped slots of the turning member. The pressing shaft 18 having a threaded end adjacent to a blocking portion end 20 and opposing stopping portion end 21. The stopping portion end 21 having engagement elements adjacent to and engaging with an outside portion of the turning piece 4 so as to squeeze the turning piece 4, thereby locking the table 3 in place. A locking handle member 22 located on the outside portion of the truing piece arc 5, the handle member 22 movably attached to pressing shaft 18 such that when the user rotates the locking handle 22 member two engagement elements move toward each other thereby pressing against the truing piece to lock the band saw machine table. The locking handle member that includes a hexagonal pillar 25 fixedly attached to the pressing shaft 18. The lock assembly also has a turning member handle 22 with a hexagonal socket seat cavity 26 corresponding to the hexagonal socket pillar 25 on one end and an attachment on the other end such that the pressing shaft extends through an opening into the turning member handle thereby preventing the turning member form departing from the pressing shaft. The lock assembly includes a spring 27 disposed around the pressing shaft with one end against the turning member handle 22 and the other end against the hexagonal pillar 25 thereby the turning member handle 22 can pulled away from the hexagonal socket 25, turned and radial repositioned to provide radial variability of the turning member handle 22, and when the handle is released the spring 27 engages the handle 22 on the hexagonal pillar 25.

The adjustable secure band saw work support table system also may include a measuring scale 23 adapted to indicate the amount of angle the table is inclined. This angle reference is the table angle relative to the blade or band-sawing machine. The measuring scale includes a graduated scale fixedly attached to the base and a pointer 24 fixedly attached to the turning piece.

The adjustable secure band saw work support tables also including a plurality of adjustment members 30, the adjustment members are positioned through the base 2 member. The adjustment members 30 being elongated threaded pieces that protrude between the base piece 2 and band saw machine base wherein the adjustment members adjust the perpendicularity between the band saw machine base and secure band saw work support table system 1. The adjustment members 30 can be a plurality of screws used to level or square the support assembly to the band saw base or band saw blade.

What is claimed is:

1. An adjustable secure band saw work support table system comprising;
a band saw machine work piece table support having,
a base member provided beneath a band saw machine worktable fixedly attached to the band saw machine base,
a single piece turning member affixed to the bottom side of the worktable, the single piece turning member having at least two arc shaped protrusions, a first arc shaped protrusion and a second arch shaped protrusion, the base member is fit between the two arc shaped turning member protrusions, each of the arc shaped turning member protrusions having at least two arched slots,
a first arch shaped slot and a second arch shaped slot, the first and second arch shapes are positioned on different radial distances from the same central axis, one of the arch shaped protrusions having a gear toothed rack formed into the arc shaped member wherein the gear toothed rack is adapted to engage a mating gear,
a blade member support guiding shaft extending through a hole in the base and into each of the first arched shaped guiding slots of the single piece turning member,
an elongated adjusting shaft extending substantially parallel to the guiding shaft and through a second hole in the base piece such that two ends of the shaft terminate adjacent to an outside periphery of the arc shaped turning member, the elongated adjusting shaft having a pinion gear engaging with the gear teeth of the turning member, the elongated shaft having a turning knob located on the distal end of the adjusting shaft,
an elongated pressing shaft extending substantially parallel to the blade member support guiding shaft and through a third hold in the base piece and into each of the second arched shaped shots of the turning member, the pressing shaft including a threaded end adjacent to a blocking portion end and opposing stopping portion end, the stopping portion end having engagement elements adjacent two and engaging with an outside portion of the turning piece so as to squeeze the turning piece, and;
a locking handle member located on the outside portion of the truing piece, the handle member attached to pressing shaft such that when the user rotates the locking handle member two engagement elements move toward each other thereby pressing against the turning piece to lock the band saw machine table from movement.

2. The adjustable secure band saw work support table as defined in claim 1 wherein the base member includes a graduated inclination measuring scale.

3. The adjustable secure band saw work support table as defined in claim 1 wherein the single piece turning member includes a pointer affixed thereto.

4. The adjustable secure band saw work support table as defined in claim 1 further comprising an elongated second guiding shaft, the second guiding shaft having two ends the second guiding shaft extending substantially parallel to the pressing shaft and through a hole in the base piece, the second guiding shaft having collars on the two ends wherein the collars are in communication with the one piece turning member guiding the turning member as the turning member is moving.

5. The adjustable secure band saw work support table as defined in claim 1 wherein the locking handle member is comprised of:
a hexagonal pillar fixedly attached to the pressing shaft;
a turning member handle with a hexagonal socket seat cavity corresponding to the hexagonal socket pillar on one end and an attachment on the other end such that the pressing shaft extends through an opening into the turning member handle thereby preventing the turning member from departing from the pressing shaft,
a spring disposed around the pressing shaft with one end against the turning member and the other end against the hexagonal pillar thereby the turning member handle can be pulled away from the hexagonal socket, turned and radial repositioned to provide radial variability of the turning member handle.

6. The adjustable secure band saw work support table as defined in claim 1 further comprising a plurality of adjustment members, the adjustment members through the base member, the adjustment members being elongated threaded pieces that protrude between the base piece and band saw machine base wherein the adjustment members adjust the perpendicularity between the band saw machine base and secure band saw work support table system

7. The adjustable secure band saw work support table as defined in claim 1 further comprising an extension member to the elongated adjusting shaft, wherein the turning knob is spaced away from the locking handle such that the locking handle and the turning knob are spaced apart.
